(19) United States
(12) Patent Application Publication
(10) Pub. No.: US 2018/0047309 A1
(43) Pub. Date: Feb. 15, 2018

(54) THREE-DIMENSIONAL CONTAINER LABEL AND METHOD OF USE

(71) Applicant: William G. Hupp, SR., Kansas City, MO (US)

(72) Inventor: William G. Hupp, SR., Kansas City, MO (US)

(21) Appl. No.: 15/677,879

(22) Filed: Aug. 15, 2017

Related U.S. Application Data
(60) Provisional application No. 62/375,099, filed on Aug. 15, 2016.

(51) Int. Cl. G09F 3/00; B65D 25/20

(52) U.S. Cl. CPC G09F 3/0289; B65D 25/205; G09F 2003/0272

(57) ABSTRACT

A three-dimensional label with an easy to identify vertical label face that is used to display a container and or content of the container. The label attaches to any part of a container to identify but not limited to the contents, name, brand, cause, purpose, person, season or medication. The primary purpose of the invention is to provide an easy to identify label for products that otherwise may be difficult to distinguish between, such as spices in a spice cabinet or medication in a medicine cabinet.

### CROSS-REFERENCE TO RELATED APPLICATION

This application claims priority in U.S. Provisional Patent Application No. 62/375,099, filed Aug. 15, 2016, which is incorporated herein by reference.

### BACKGROUND OF THE INVENTION

### 1. Field of the Invention

The present invention relates generally to a label system and method for use thereof, and more specifically to a three-dimensional label for use with containers and other objects.

### 2. Description of the Related Art

Existing labels typically are located on the body of containers or on the tops of the containers. This can make it difficult to quickly identify a container when it is stored amongst other similarly shaped containers, such as in a spice shelf or medicine cabinet. What is needed is a label that can easily be viewable amongst several similarly shaped containers or items from all directions and which can be customized.

Heretofore there has not been available a system or method for a three-dimensional container label with the advantages and features of the present invention.

### BRIEF SUMMARY OF THE INVENTION

The present invention generally provides a three-dimensional label with an easy to identify vertical label face that is used to display a container and/or contents of the container. The label attaches to any part of a container to identify but is not limited to the contents, name, brand, cause, purpose, person, season or medication. The primary purpose of the invention is to provide an easy to identify label for products that otherwise may be difficult to distinguish between, such as spices in a spice cabinet or medication in a medicine cabinet.

The label could contain a picture for visually impaired or illiterate persons, braille for the blind, or words or colors as desired by the user. The vertical face could be labeled, and the horizontal faces could also be labeled or could contain other information, such as purchase or expiration date (for foods and spices) or dosage instructions (for medications). Other possible labels include business taglines or company identifying marks, such as trademarks and logos.

The label could be used on other items other than containers, such as to identify inventory or products on shelves. The label could even be used as three-dimensional business cards or for other identification purposes.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention shown in a typical environment.

FIG. 2 is a three-dimensional isometric view of the embodiment thereof shown in isolation.

FIG. 3 is a front elevational view thereof.

FIG. 4 is a right side elevational view thereof, the left side view being a mirror image thereof

FIG. 5 is a top plan view thereof.

FIG. 6 is a three-dimensional isometric view of the embodiment thereof shown in an alternative orientation in an alternative environment.

FIG. 7 is a top isometric view of an alternative embodiment of the present invention shown in an unfolded orientation.

FIG. 8 is a top isometric view thereof shown in a folded orientation.

FIG. 9 is a top isometric view thereof shown in a folded orientation and in proximity with a base block.

FIG. 10 is a top plan view of another alternative embodiment of the present invention shown in an unfolded orientation.

FIG. 11 is a top plan view thereof shown in a folded orientation.

FIG. 12 is a side elevational view thereof showing the process of transforming the embodiment thereof from a first, unfolded orientation into a second, folded orientation.

FIG. 13 is a front elevational view of yet another alternative embodiment thereof

FIG. 14A is a three-dimensional isometric view of yet another alternative embodiment of the present invention including a sound alert feature.

FIG. 14B is a three-dimensional isometric view of the embodiment thereof including a visual alert feature.

FIG. 15 is a three-dimensional isometric view of even yet another alternative embodiment of the present invention.

FIG. 16 is a frontal three-dimensional isometric view of even yet another alternative embodiment of the present invention.

FIG. 17 is a three-dimensional isometric view of another alternative embodiment of the present invention shown in a typical environment.

FIG. 18 is a front elevational view thereof shown in an flat orientation.

FIG. 19 is a front elevational view of a slightly altered design thereof.

FIG. 20 is a three-dimensional isometric view of another alternative embodiment of the present invention with foldable flaps.

FIG. 21 is a three-dimensional isometric view of yet another alternative embodiment of the present invention with a spiked portion.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as oriented in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning. Additional examples include a mobile smart device including a display device for viewing a typical web browser or user interface will be commonly referred to throughout the following description. The type of device, computer, display, or user interface may vary when practicing an embodiment of the present invention. Said terminology will include the words specifically mentioned, derivatives thereof and words of similar meaning.

### II. Preferred Embodiment Labeling System 2

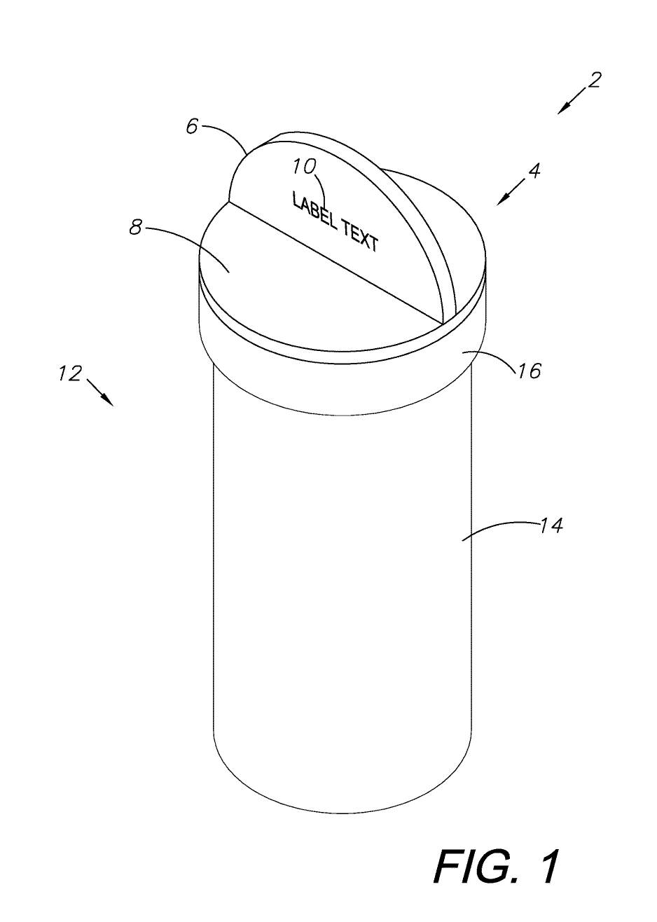

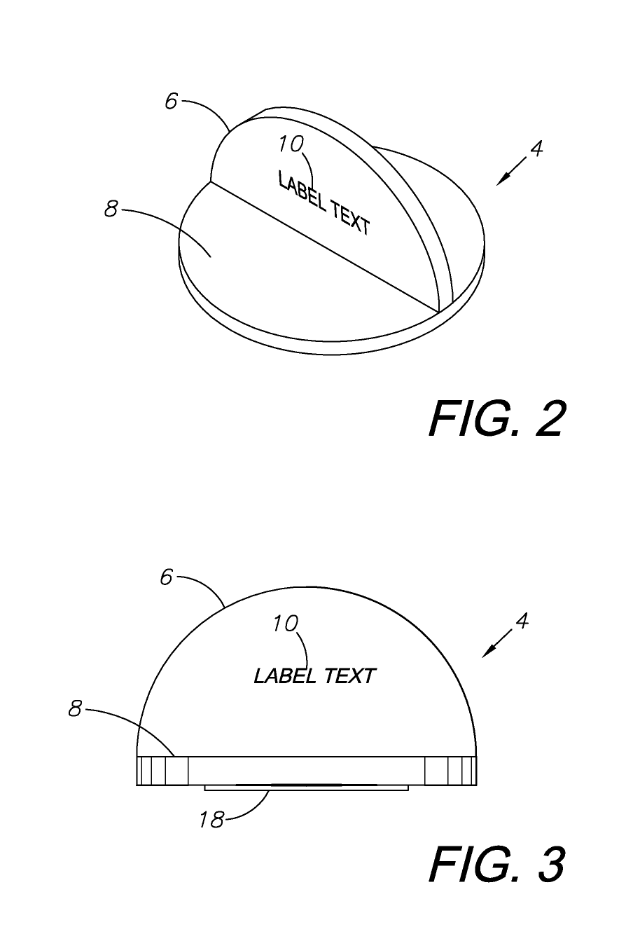

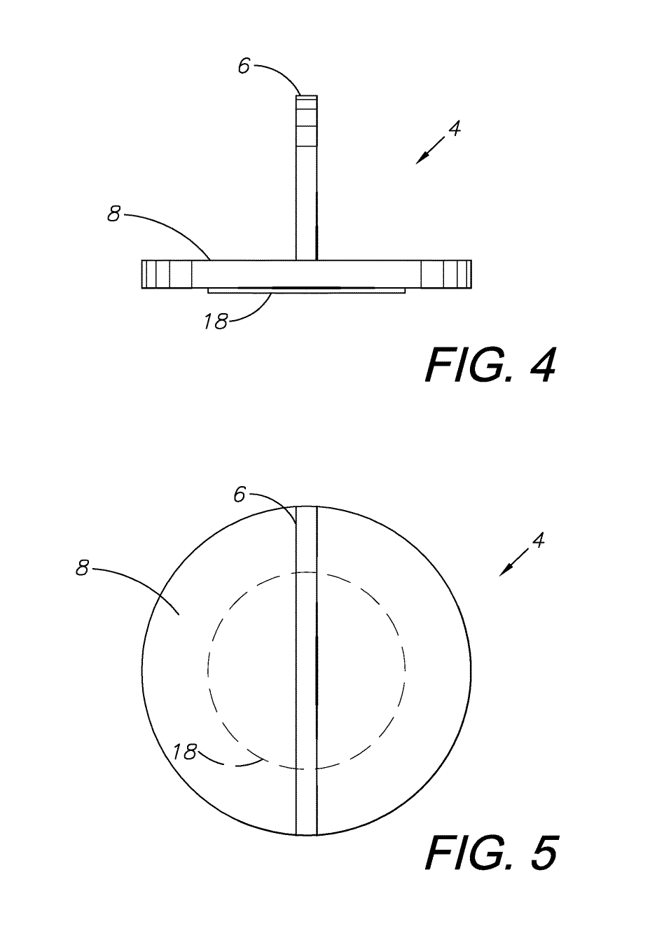

As shown in the FIGS. 1-5, the primary purpose of the present invention is to provide a three-dimensional label 4 for easy identification of goods, such as containers 12 (e.g. spices and medicines). The primary components of the label 4 are a base unit 8 which is affixed to the container lid 16 atop a container body 14, or any other item, and a vertical top portion 6 which extends perpendicularly from the base including a face which contains an identifier 10, such as words, symbols, pictures, colors, or even braille.

FIGS. 1-5 show a solid embodiment of the present invention which could come out of the package ready to use. An adhesive disc element 18 is applied to the bottom of the base 8, such as a reusable adhesive sticky pad. The structure of the embodiment allows the user to use the vertical portion 6 of the label to open bottle containers using the label itself, providing an easier way to open the lids for people who have difficulties with their hands or fingers. The label 4 can also be used to more easily pick up the container.

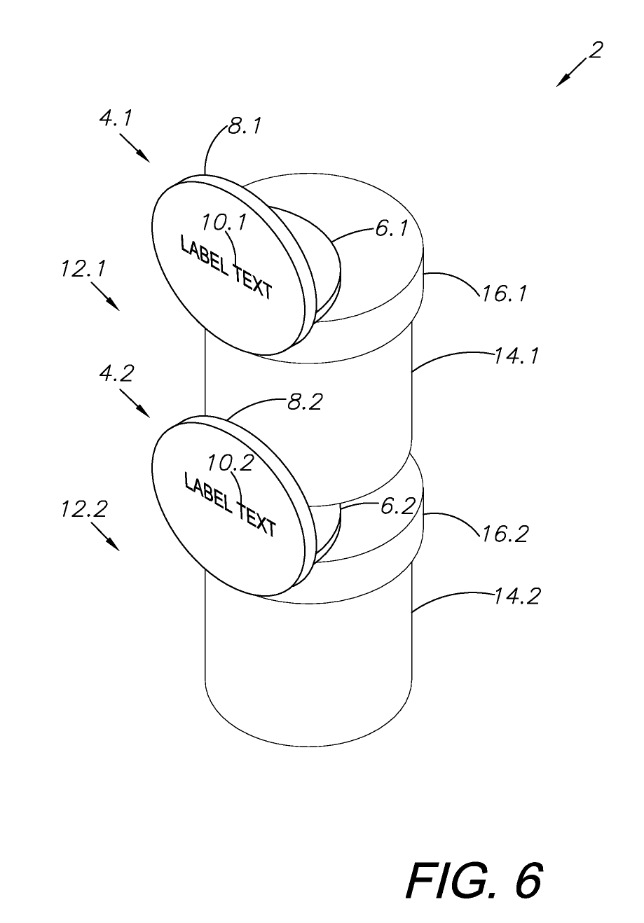

FIG. 6 shows the label 4 being used in an alternative orientation, where a first label 4.1 is placed atop a first container 12.1 having a body 14.1 and lid 16.1 by the top portion 6.1 of the label 4.1. The text 10.1 is located on the bottom face of the base 8.1 in this orientation. This entire combination is stacked atop at least a second container 12.2 having a body 14.2 and lid 16.2 by the top portion 6.2 of the second label 4.2. The text 10.2 is located on the bottom face of the base 8.2 as above. This could be stacked multiple ways and in any multiple combinations.

### III. Alternative Embodiment Label System 52

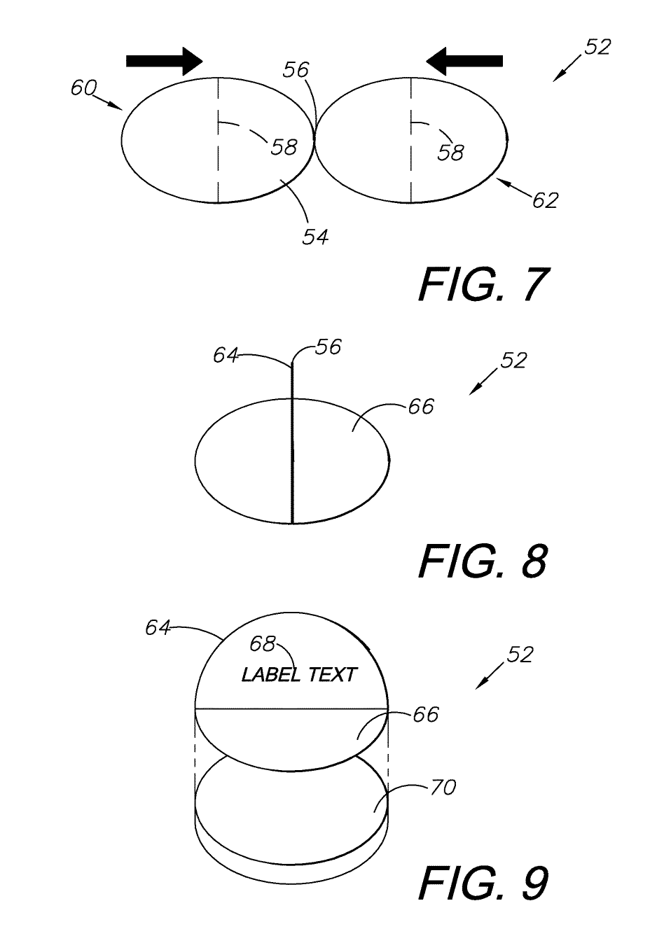

FIGS. 7-9 show a foldable embodiment of the present invention, which may be made out of heavy paper, vinyl, plastic, or any other suitable material cut into a flat base 54. The device would have score lines 58 for folding the central portion up to form the vertical element 64 of the label, whereby the base 66 is formed by the second halves of the first 60 and second 62 circles. The two circles 60, 62 are joined at a central portion 56. This embodiment could be used without a substrate or with a substrate, as shown in FIGS. 5-7. The substrate could provide additional structure and stability to the device. This embodiment makes a product which is smaller in shape, and therefore easier to store and ship. The label text 68 would appear on the vertical portion 64. An optional cylindrical substrate base 70, made of a sturdy material such as wood, plastic, cardboard, or other suitable material could be affixed to the base 66 for a more sturdy label.

### IV. Alternative Embodiment Label System 102

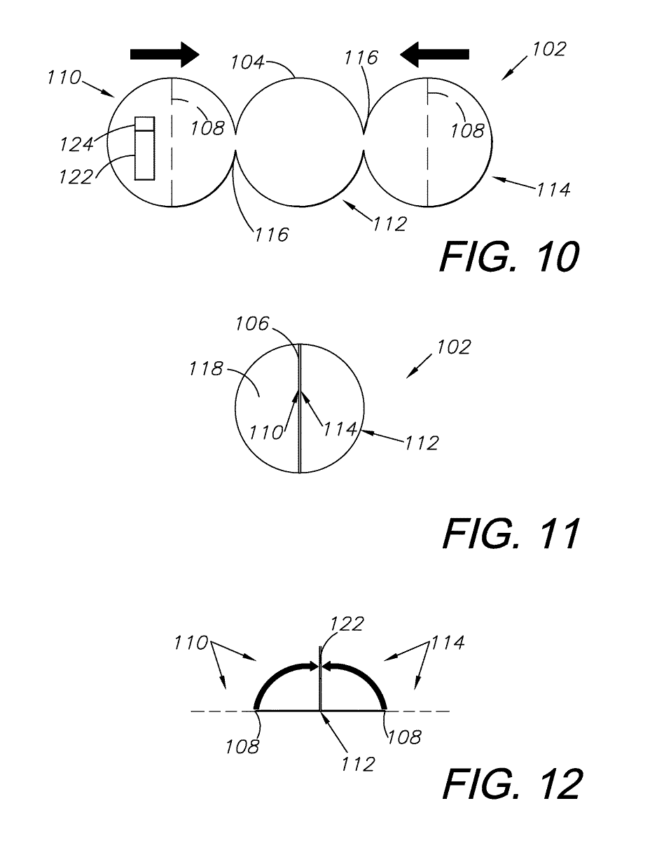

FIGS. 10-12 show a slightly alternative embodiment of a foldable embodiment 104 including a basic three-circle device with score lines 108 allowing the device to be folded up. This design makes the need for the substrate 70 shown in the previous embodiment irrelevant. A ready-to-use adhesive strip 122 could be applied to one or more faces of the device, as shown in FIG. 12, which can allow the vertical portion 106 to be easily formed out of the two edges 110, 114 as shown in FIG. 12. The base portion 118 is then formed out of the center circle 112 and the other halves of the outer circles 110, 114. The three circles 110, 112, 114, are separated by center portions 116 which allow folding about those portions. The adhesive strip 122 includes a pull-away cover 124 which exposes the adhesive, allowing the two side circles 110, 114 to be folded together to form the base 118 and vertical portions 106 of the label.

### V. Alternative Embodiment Label System 152

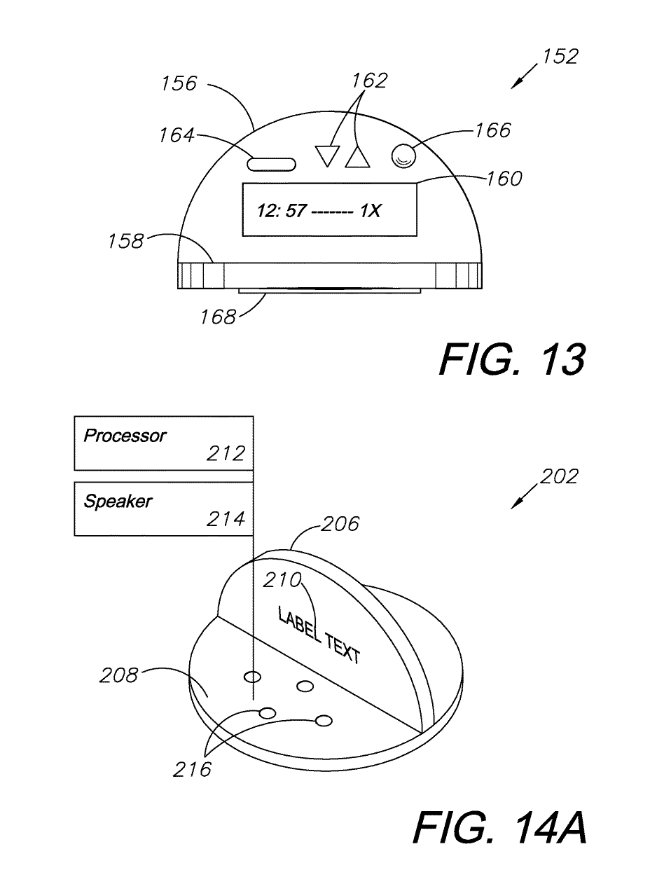

FIG. 13 shows a digital version of a label system 152 similar to those disclosed above. The label includes a base portion 158 and a vertical top portion 156. The top portion includes an LCD screen 160 which could include the label text, a timer, or other data. A set button 164, adjustment buttons 162, and LED alert device 166 round out the digital portion of the device. A processor, battery, and other devices may be needed to add functionality to the device. The adjustment buttons 162 adjust timer settings, and the set button 164 will set the alarm. When it is time to open the container the label 152 is placed upon (e.g., medicine container), the alert sounds and the light 166 flashes. A speaker may also be included. An adhesive disc 168 is placed on the bottom face of the base portion 158 and allows the label to be adhered to a container.

### VI. Alternative Embodiment Label System 202

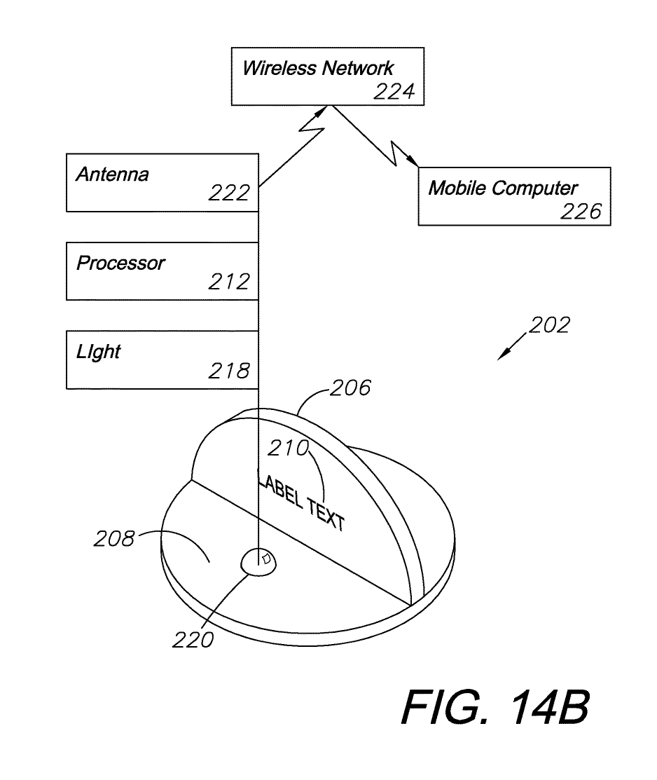

FIGS. 14A and 14B show yet another alternative embodiment label system 202. Here, the base portion 208 and top portion 206 are very similar to the previous embodiments, including the label text 210 on the top portion. However, a processor 212 is included which is connected to a speaker 214 which may produce audio through a plurality of audio holes 216.

Alternatively, as shown in FIG. 14B, a light element 220 including a light source 218 could be used for hearing-impaired users. The speaker 214 or light 218 can be used to alert a user when they should open the container and take their medicine or for other alert purposes. An antenna 222 may also be included to connect the label 202 through a wireless network 224, such as the internet, to a wireless mobile computer 226, such as a smartphone or laptop computer. This allows the alert to be sent to the user at a remote location, not within audio or visual contact of the label 202.

### VII. Alternative Embodiment Label System 252

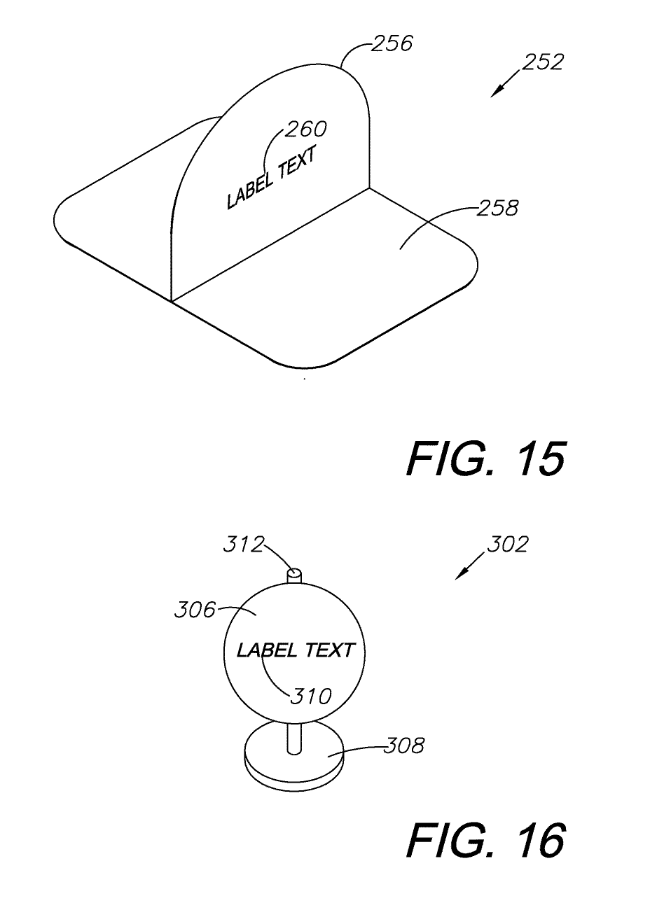

FIG. 15 shows a slightly alternative embodiment label system 252 made again of a base portion 258, vertical top portion 256, and label text 260. Such a label could be folded up from a business card or other flat card-shaped element.

### VIII. Alternative Embodiment Label System 302

FIG. 16 shows yet another slightly alternative embodiment label system 302 including a base portion 308, vertically oriented top portion 306 including label text 310, and the vertical portion being supported by a vertical rod 312.

### IX. Alternative Embodiment Label System 352

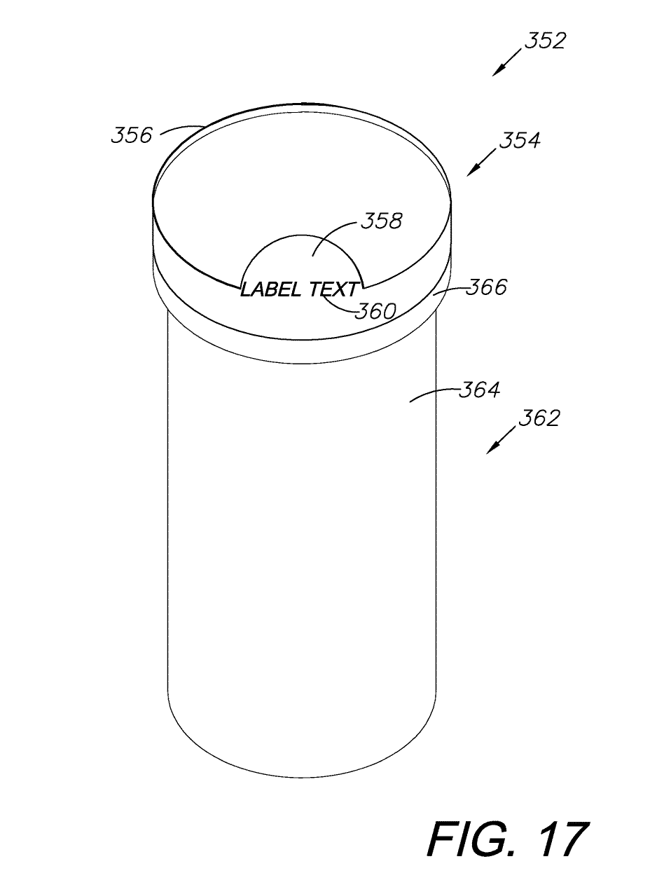

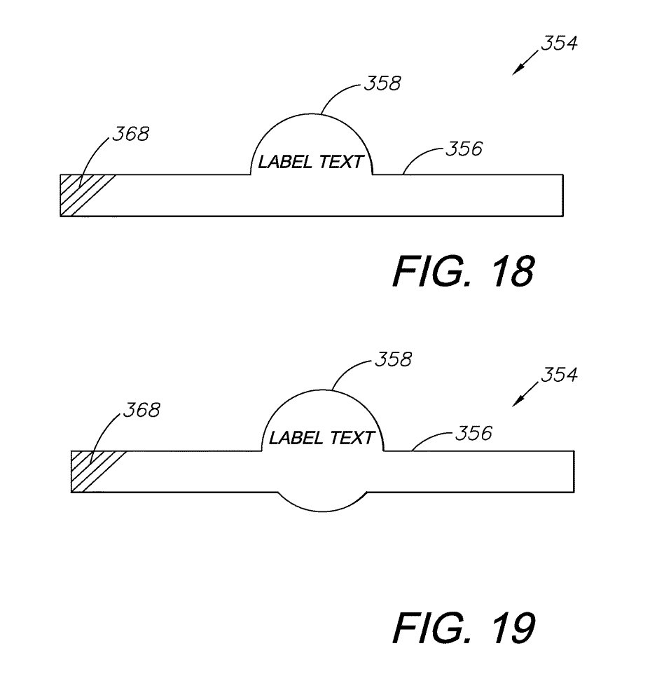

FIGS. 17-19 show another alternative embodiment label system 352 of a label 354 shown in a typical environment about a container lid 366 atop a container body 364 of a container 362. The label 354 is formed from a banded portion 356 and a label-face portion 358 including the label text 360. FIG. 19 shows a slightly alternative design in the label-face portion 358. An adhesive portion 368 can be peeled away to allow the two halves of the banded portion 356 to connect firmly about the container 362.

### X. Alternative Embodiment Label 404

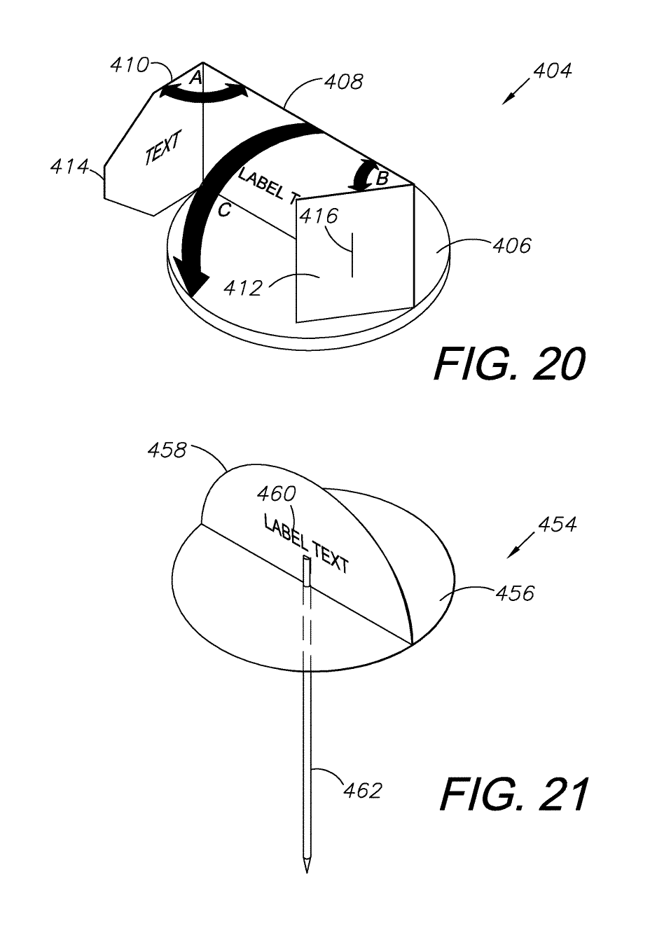

FIG. 20 shows another alternative embodiment label 404 which has a base 406 similar to other embodiments disclosed above. A top flap 408 which can fold along arrow C as shown in FIG. 20 contains label text. A first flap 410 and second flap 412 can fold out from the top flap 408 and can contain other text, images, or information. The first flap 410 may include a tab 414 which slots into a slit 416 of the second flap, allowing the first flap 410 and second flap 412 to close against the top flap 408.

### XI. Alternative Embodiment Label 454

FIG. 21 shows another alternative embodiment label 454 which includes a top portion which is very similar to some of the embodiments disclosed above, including a base portion 456 and a top portion 458 perpendicular to the base portion. Label text 460 is placed on the vertically oriented top portion. A spike 462, such as a toothpick or metal wire, is inserted or otherwise affixed to the base 456 and/or top portion 458 and allows the label to be inserted into food, containers, a paper label for a bottle, or other uses such as in potted plants or gardens.

Alternative uses of the invention include use as a three-dimensional business card or name tag (see FIG. 15). As a name tag, the device could be affixed to the base of a wine glass or other object to identify an object to its owner. Other features may include LED lights or other lighting elements attached to the base portion of the device to illuminate the vertical face, or placed in proximity with the device itself.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A three-dimensional labeling system comprising:
a three-dimensional label having a base portion and a top portion;
said top portion being perpendicular to said base portion; and
said base portion and said top portion configured for receiving label information.

2. The system of claim 1, further comprising:
said base portion being generally circular in shape;
said top portion comprising a half-circle; and
said base portion configured for being placed atop a container.

3. The system of claim 2, wherein said three-dimensional label configured to be transformed from a flat orientation to a deployed orientation.

4. The system of claim 3, further comprising:
said label in said flat orientation comprising first circle and a second circle;
a first score line passing through the center of said first circle thereby creating an interior half and an exterior half of said first circle;
a second score line passing through the center of said second circle thereby creating an interior half and an exterior half of said second circle;
said interior half of said first circle joined to said interior half of said second circle;
whereby said first circle and second circle are configured to be folded about said first score line and said second score line; and
whereby said top portion is comprised of said interior half of said first circle and said interior half of said second circle, and said base portion is comprised of said exterior half of said first circle and said exterior half of said second circle.

5. The system of claim 3, further comprising:
said label in said flat orientation comprising a first circle, a second circle, and a third circle;
a first score line passing through the center of said first circle thereby creating an interior half and an exterior half of said first circle;
a second score line passing through the center of said second circle thereby creating an interior half and an exterior half of said second circle;
said third circle being located between said first circle and said second circle;
said interior half of said first circle joined to said third circle;
said interior half of said second circle joined to said third circle opposite of said first circle;
whereby said first circle and second circle are configured to be folded about said first score line and said second score line; and
whereby said top portion is comprised of said exterior half of said first circle and said exterior half of said second circle, and said base portion is comprised of said interior half of said first circle and said interior half of said second circle placed flat against said third circle.

6. The system of claim 5, further comprising:
an adhesive strip located on said exterior half of said first circle; and
said adhesive strip configured to affix said exterior half of said first circle to said exterior half of said second circle.

7. The system of claim 2, wherein said label information comprises a braille message.

8. The system of claim 2, further comprising:
a processor and battery stored within said base portion;
a display screen located on said top portion, said display screen configured for displaying said label information;
a plurality of timer controls configured for interfacing with said processor; and
whereby said processor is configured to control a timer and displaying a timer display as a portion of said label information.

9. The system of claim 8, further comprising:
a light emitting diode (LED); and
said processor configured to illuminate said LED upon generating a timer alert based upon said timer.

10. The system of claim 8, further comprising:
a speaker; and
said processor configured to produce a sound from said speaker thereby generating a timer alter based upon said timer.

11. The system of claim 2, further comprising:
a vertical spike affixed to said base portion; and
said vertical spike extending downwardly, perpendicular to said base portion, said vertical spike configured for being inserted into a body.

12. The system of claim 1, further comprising:
said top portion being foldable against said base portion, thereby transforming from a vertical orientation to a horizontal orientation; and
wherein said label information comprises business card text.
